(19) United States
(12) Patent Application Publication
(10) Pub. No.: US 2018/0189825 A1
(43) Pub. Date: Jul. 5, 2018

(54) ANALYSIS OF EFFECTIVENESS OF AN ONLINE ADVERTISING CAMPAIGN

(71) Applicant: MASTERCARD ASIA/PACIFIC PTE. LTD., Singapore (SG)

(72) Inventors: Eric Jian Hui Lin, Singapore (SG); Benjamin Charles Gilbey, Singapore (SG); Ai Ling Felicia Choo, Singapore (SG)

(73) Assignee: MASTERCARD ASIA/PACIFIC PTE. LTD., Singapore (SG)

(21) Appl. No.: 15/861,509

(22) Filed: Jan. 3, 2018

(30) Foreign Application Priority Data
Jan. 4, 2017 (SG) 10201700052T

(51) Int. Cl. G06Q 30/02; G06F 17/18

(52) U.S. Cl. CPC G06Q 30/0246; G06F 17/18; G06Q 30/0277

(57) ABSTRACT

According to a first aspect, there is provided an advertising campaign analyser comprising: at least one processor; and at least one memory including computer program code; an input port coupled to the processor; the at least one memory and the computer program code configured to, with the at least one processor, cause the analyser at least to: receive, through the input port, advertising campaign data extracted from a response to advertising material belonging to an online advertising campaign, the advertising campaign data comprising at least one recipient account to which the advertising material is delivered; receive, through the input port, payment data generated from purchases made at a merchant participating in the online advertising campaign; analyse the received advertising campaign data and the received payment data to identify data fields from the received payment data that establishes a correlation to the at least one recipient account from the received advertising campaign data; generate statistical data related to purchases attributable to the online advertising campaign, the attribution being based at least partially on a degree of the established correlation; and compile a report containing one or more of the generated statistical data.

### CROSS-REFERENCE TO RELATED APPLICATIONS

This application claims the priority of Signapore Application Serial No. 10201700052T, filed Jan. 4, 2017, which is incorporated herein by reference in its entirety.

### TECHNICAL FIELD

The following discloses a method and device to analyse an effectiveness of an online advertising campaign.

### BACKGROUND

An advertising network performs online advertising by serving online advertisements to consumers browsing the internet. The advertising network is able to measure user interaction with the advertisement, such as whether the user has viewed or clicked on the advertisement. To determine whether there is actual conversion, i.e. purchase resulting from the online advertisement, an additional mechanism such as a coupon code or a promotion redemption code is introduced into the advertisement by the merchant ordering the online advertisement to track actual conversion and a success rate of the advertising campaign.

However, tracking the effectiveness of an advertising campaign through the use of the coupon code or the promotion redemption code may not provide accurate results. For instance, a customer may be informed of the coupon code or the promotion redemption code through a third party (such as the customer's friend), rather than from visiting the website containing the code.

There is thus a need to provide an alternative mechanism to track the effectiveness of an online advertising campaign. Other desirable features and characteristics will become apparent from the subsequent detailed description and the appended claims, taken in conjunction with the accompanying drawings and this background of the present disclosure.

### SUMMARY OF THE INVENTION

According to a first aspect, there is provided an advertising campaign analyser comprising: at least one processor; and at least one memory including computer program code; an input port coupled to the processor; the at least one memory and the computer program code configured to, with the at least one processor, cause the analyser at least to: receive, through the input port, advertising campaign data extracted from a response to advertising material belonging to an online advertising campaign, the advertising campaign data comprising at least one recipient account to which the advertising material is delivered; receive, through the input port, payment data generated from purchases made at a merchant participating in the online advertising campaign; analyse the received advertising campaign data and the received payment data to identify data fields from the received payment data that establishes a correlation to the at least one recipient account from the received advertising campaign data; generate statistical data related to purchases attributable to the online advertising campaign, the attribution being based at least partially on a degree of the established correlation; and compile a report containing one or more of the generated statistical data.

According to a second aspect, there is provided a method of analysing effectiveness of an online advertising campaign, the method comprising: receiving advertising campaign data extracted from a response to advertising material belonging to the online advertising campaign, the advertising campaign data comprising at least one recipient account to which the advertising material is delivered; receiving payment data generated from purchases made at a merchant participating in the online advertising campaign; analysing the received advertising campaign data and the received payment data to identify data fields from the received payment data that establishes a correlation to the at least one recipient account from the received advertising campaign data; generating statistical data related to purchases attributable to the online advertising campaign, the attribution being based at least partially on a degree of the established correlation; and compiling a report containing one or more of the generated statistical data.

### BRIEF DESCRIPTION OF THE DRAWINGS

The accompanying Figures, where like reference numerals refer to identical or functionally similar elements throughout the separate views and which together with the detailed description below are incorporated in and form part of the specification, serve to illustrate various embodiments and to explain various principles and advantages in accordance with a present embodiment, by way of non-limiting example only.

Embodiments of the invention are described hereinafter with reference to the following drawings, in which:

FIGS. 1A and 1B each show a schematic of a system which allows analysis of the effectiveness of an online advertising campaign.

FIG. 2 shows a schematic of a report generated by the advertising campaign analyser of FIGS. 1A and 1B.

FIG. 3 shows a schematic of a computing device used to realise the advertising campaign analyser shown in FIGS. 1A and 1B.

FIG. 4 shows a flowchart depicting steps of a method for analysing effectiveness of an online advertising campaign.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other computing device selectively activated or reconfigured by a computer program stored therein. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on a computer effectively results in an apparatus that implements the steps of the preferred method.

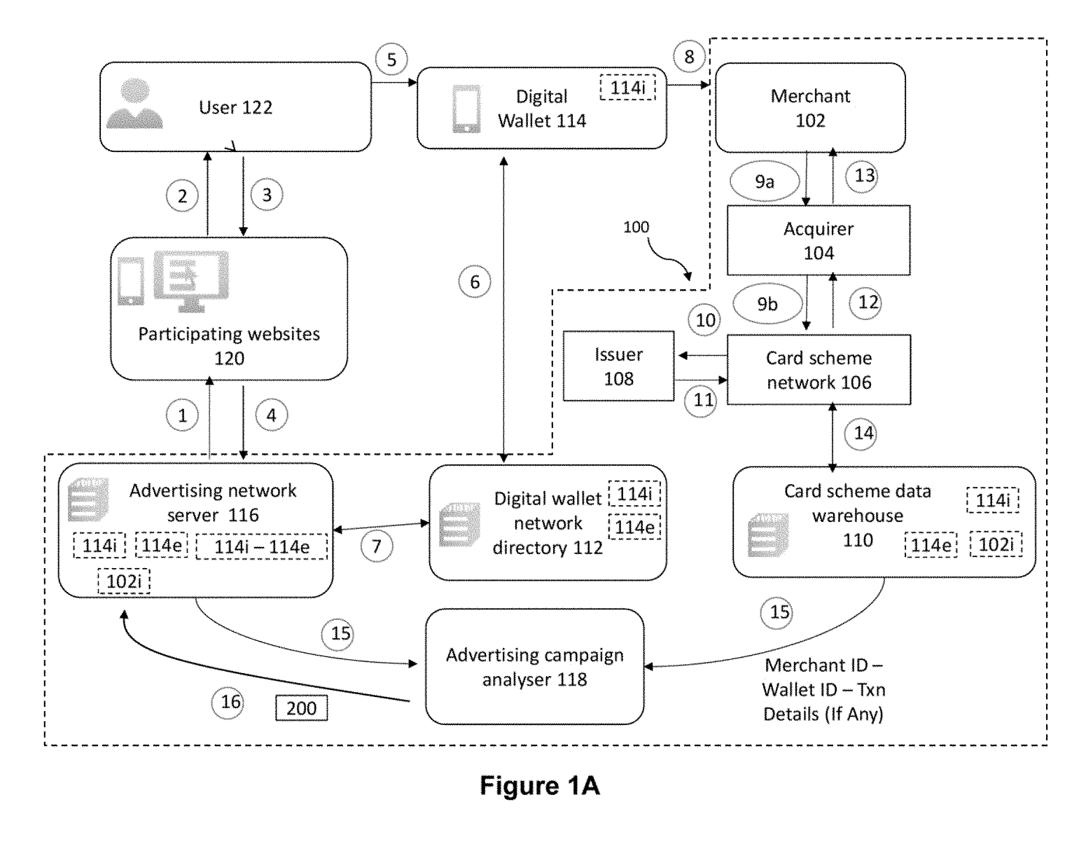

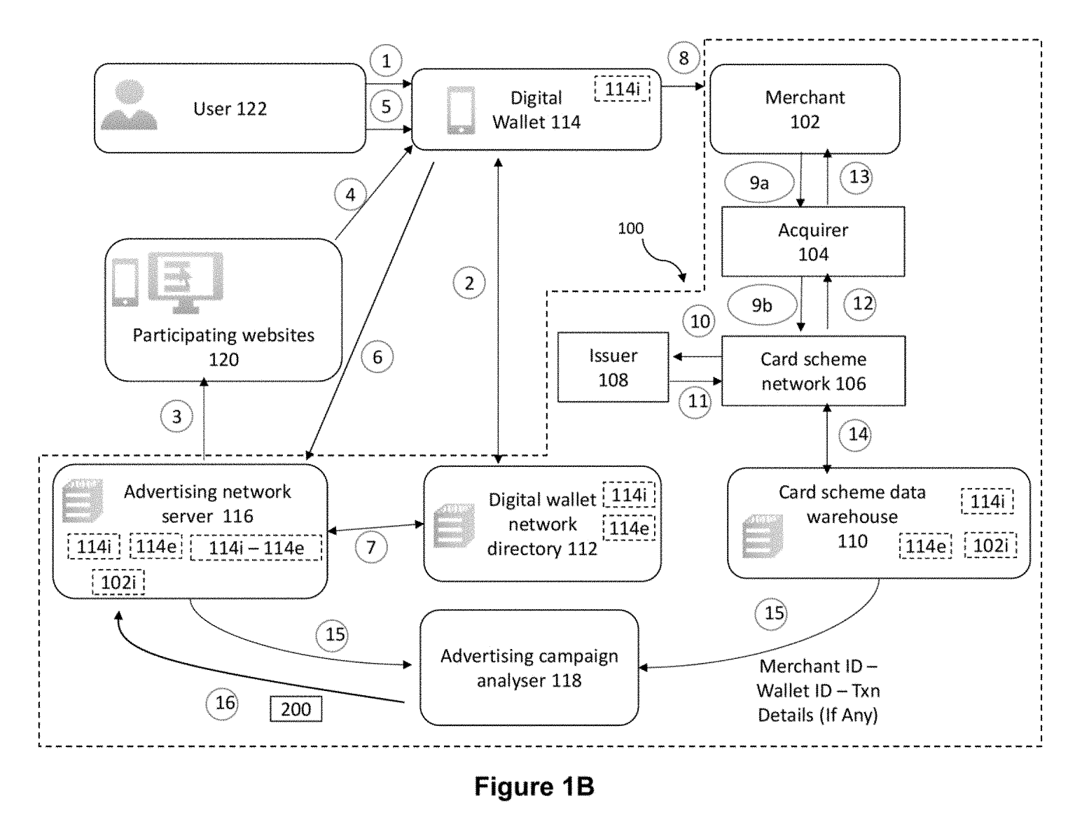

FIGS. 1A and 1B each show a schematic of a system 100 which allows analysis of the effectiveness of an online advertising campaign. An online advertising campaign refers to advertising through an electronic medium, such as on a website owned by a merchant that is advertising its goods or services. However, the electronic medium is not necessarily restricted to the merchant's website, but includes outreach through alternative channels, like placement of advertising material which includes posting on social media platforms (such as Twitter® and Facebook®), contributions into forums dedicated to categories under which the merchants good or services fall and transmission of advertising content to smartphone applications. Examples of these postings, contributions and advertising content include pictures, text or a combination of both. In addition, offline merchants, i.e. merchants that do not have a website address, may also participate in the online advertising campaign and advertise their goods or services through the electronic medium used by the online advertising campaign.

The system 100 is able to identify information flowing within the system 100 that can be used to generate statistical data usable to analyse or measure the effectiveness of an online advertising campaign. In the context of the present disclosure, the effectiveness of an online campaign advertising campaign may be measured from its impact on consumer response to the merchant 102 goods or services through, for example, purchases that can be attributable to (or determined to result from) the online advertising campaign. The manner in which information used to measure the effectiveness of an online advertising campaign is identified is explained below, in conjunction with a description of each of the components of the system 100.

The system 100 comprises a merchant 102, an acquirer 104, a card scheme network 106, an issuer 108, a card scheme data warehouse 110, a digital wallet network directory 112, an advertising network server 116 and an advertising campaign analyser 118.

The merchant 102 is a participant in the online advertising campaign, from, for example, commissioning or paying for an online advertising campaign on its provided goods or services. The merchant 102 thus has an interest in learning the conversion rate of the online advertising campaign, i.e. whether investing in the online advertising campaign indeed leads to growth in sales of its provided goods and services and if so, what percentage of its sold goods and services would be attributable to or result from the online advertising campaign.

The merchant 102 communicates with the acquirer 104 through, for example, a payment interface, such as a point of sale (POS) terminal (not shown). The acquirer 104 is in turn in data communication with the card scheme network 106, which acts as an intermediary for allowing payment data to be routed between the acquirer 104 and the issuer 108.

It will be appreciated that the merchant 102, the acquirer 104, the card scheme network 106 and the issuer 108 form the four party model from Visa® or MasterCard® for processing electronic payment made using their financial systems. The card scheme network 106 acts as a switch that routes the payment data between the acquirer 104 and the issuer 108. In the four party model, the acquirer 104 is called so because it ‘acquires’ the payment data from the merchant 102 where purchases are made. The issuer 108 is so called, because it is the entity that has ‘issued’ the payment instrument on which the purchases are made.

The card scheme data warehouse 110 is a database server for storing information associated with successful transactions that are facilitated by the card scheme network 106. Such information includes payment data generated from purchases made using an electronic means, such as a payment card or a digital wallet application, such as the digital wallet application 114 shown in FIGS. 1A and 1B. The card scheme data warehouse 110 obtains such payment data from being in communication with the card scheme network 106.

The digital wallet network directory 112 is a server that hosts electronic payment applications, from which the digital wallet application 114 is downloaded or obtained. During the download or set-up of the digital wallet application 114, a digital wallet identifier 114i is assigned to the digital wallet application 114. An electronic address may also be obtained as part of the digital wallet application 114 registration process, i.e. the electronic address is used to register the digital wallet application 114. The electronic address may for example be a unique identifier of a mobile terminal in which the digital wallet application 114 is installed, such as a smart phone with an advanced mobile operating system, like iOS of Apple Inc. or Android of Google Inc. Such an electronic address may thus be an IMEI code (International Mobile Equipment Identity) of the mobile terminal, which may be obtained automatically during the set-up or download of the digital wallet application 114. Alternatively, the electronic address may be an email address, provided to the digital wallet network directory 112 during the download or set-up of the digital wallet application 114. The digital wallet identifier 114i and the electronic address used to register the digital wallet application are stored on the digital wallet network directory 112.

The advertising network server 116 is a server that provides a push notification service to a specified destination, which is typically a recipient account. Recipient accounts include an electronic address like a personal email account, a user account registered with a social media platform like Facebook®, Twitter®, a website address and a smartphone application. The advertising network server 116 will keep a record of the recipient accounts to which the advertising material is delivered and will transmit this record to the advertising campaign analyser 118.

In the case of the personal email account, the advertising network server 116 may perform the push notification service by sending advertising material (such as an email with images, text or both) to the personal email account. In the case of the social media platform, the advertising network server 116 may serve advertising material (such as a banner, poster or picture) that is displayed on a public page of the user account. In the case of a website address, the advertising network server 116 may configure the website address to display advertising material on one of the website address pages.

In the case of a smartphone application, the recipient account may be a digital wallet application 114 installed in the mobile terminal, that receives the pushed content of the advertising material. The pushed notification includes website links of websites participating in the online advertising campaign, i.e. content which contains a link to one or more websites hosing the advertising material of goods or services sold by the merchant 102 is sent to the mobile terminal. The pushed notification may also include a message notification containing the advertising material, such as a banner, poster or picture. In this manner, the advertising network server 116 is able to serve an advertisement of goods or services being provided by the merchant 102 to a user 122 of the mobile terminal in which the digital wallet application 114 is installed.

The advertising campaign analyser 118 is a server in which the analysis of the effectiveness of an online advertising campaign is performed. The advertising campaign analyser 118 performs this analysis by drawing conclusions from processing a data stream received from the advertising network server 116 and another data stream received from the card scheme data warehouse 110.

The data stream received from the advertising network server 116 provides advertising campaign data. The advertising campaign data refers to data extracted from a response to advertising material belonging to an online advertising campaign. The advertising campaign data will provide an indicator of an electronic address that is providing the response, i.e. the advertising campaign data includes at least one recipient account to which the advertising material is delivered. Consider the implementation where the advertising material is hosted in websites participating in the online advertising campaign, where it is described above that website links to these websites are provided to the digital wallet application 114 through a push notification by the advertising network server 116. It is when these provided or pushed website links are responded to, for example, by detecting that the mobile terminal in which the digital wallet application 114 is installed selects the website links, that data generated from such a response is captured or extracted. Similarly, when advertising material delivered to a recipient account is responded to, for example, by detecting that there has been interaction with the advertising material (such as being selected or dismissed), that data generated from such a response is captured or extracted. This generated data that is extracted is termed as the “advertising campaign data” since it results from advertising performed by the advertising network server 116. The recipient account, being part of the advertising campaign data, may include any one or more of the electronic address to which the advertising material is delivered, an electronic address used to register the digital wallet application 114, a digital wallet identifier 114i of the digital wallet application 114 and a merchant identifier of a merchant hosting the advertising material (which may be the same as the merchant 102 from which purchases are made, since the merchant 102 can own the websites hosting the advertising material).

The data stream received from the card scheme data warehouse 110 provides payment data generated from purchases made at the merchant 102 which is participating in the online advertising campaign. These purchases may be made using the digital wallet application 114, whereby the payment data refers to electronic records captured by a POS terminal of the merchant 102 against which the digital wallet application 114 makes contactless payment. Alternatively, the purchases may be made using a payment vehicle such as a stored value card, a credit card or a debit card. Examples of the payment data include any one or more of an electronic address used to register the payment vehicle, an electronic address used to register the digital wallet application 114, a digital wallet identifier 114i of the digital wallet application 114 and a merchant identifier of the merchant 102 from whom the purchases are made and transaction details of the purchases made.

The advertising campaign analyser 118 will analyse the received advertising campaign data and the received payment data to identify data fields from the received payment data that establishes a correlation to the at least one recipient account from the received advertising campaign data. Such data fields are identified because they because they are used by the advertising campaign analyser 118 as one factor to conclude that the advertising material achieved its objective of resulting in the purchase which generated that set of payment data. Recall from the above that the advertising network server 116 provides the advertising campaign analyser 118 with the recipient accounts to which the advertising material is delivered. With the recipient account on hand, the advertising campaign analyser 118 detects for the existence of data fields, within the received payment data, that can establish a correlation to these recipient accounts, when determining which purchases are attributable to such advertising material.

The advertising campaign analyser 118 may identify the data fields that are correlated to the recipient account by determining whether the received payment data has data fields that can be linked back to the recipient account. A direct correlation exists when one or more of the data fields in the received payment data identically matches a corresponding one or more of the recipient accounts to which the advertising material is delivered. Such a direct correlation occurs when a recipient of the advertising material responds to the advertising material, for example, by clicking on it. However, a party, who does not receive the advertising material may learn of it from seeing the advertising material displayed, for example, on a social media platform to which a recipient of the advertising material has an account. A response to advertising material from such a party will still be captured in the form of a suitable indicator, such as a referral flag, and payment data resulting from purchase of this party will thus contain this referral flag, i.e. data fields traceable to the recipient account. When such data fields are processed, the trail showing that this party learnt of the advertising material from a recipient of the advertising material will be uncovered and will factor into the determination of a degree of correlation that these data fields have with the recipient account to which the advertising material is delivered. The correlation of data fields traceable to the recipient account will be indirect, as opposed to the direct correlation for data fields which match the recipient account. The advertising campaign analyser 118 is further configured to identify the data fields traceable to the recipient account by determining whether a referral flag is raised, the referral flag indicating that the advertising material is located through the recipient account.

It will be appreciated that the advertising campaign analyser 118 may refer to a mapping table when performing the analysis of the received advertising campaign data and the received payment data to identify data fields from the received payment data that establishes a correlation to the at least one recipient account from the received advertising campaign data. This is especially the case when the received advertising campaign data and the received payment data contain pointers which the mapping table uses to uncover these data fields.

The advertising campaign analyser 118 then generates statistical data related to purchases attributable to the online advertising campaign, i.e. purchases that are determined to result from the provision of the website links to the digital wallet application 114. This attribution is based at least partially on a degree of the established correlation. The degree of the established correlation is a measure of the strength of the linkage between the identified data fields; used to establish correlation with the recipient account that has received the advertising material, and the recipient account. In one implementation, the degree of the established correlation depends on whether the identified data fields matches the at least one recipient account or are data fields traceable to the recipient account. The identified data fields matches the at least one recipient account when one or more of the electronic address, the digital wallet identifier 114i of the digital wallet application 114 and the merchant identifier of the received advertising campaign data is the same as a respective one of the electronic address, the digital wallet identifier 114i and the merchant identifier of the received payment data.

Additional criteria that may be considered when determining the degree of correlation includes the location of devices that receive the advertising material, the date and time the advertising material is received, the date and time of the purchases and the extent of engagement with the advertising material (such as a duration over which the advertising material was studied or whether the advertising material was dismissed).

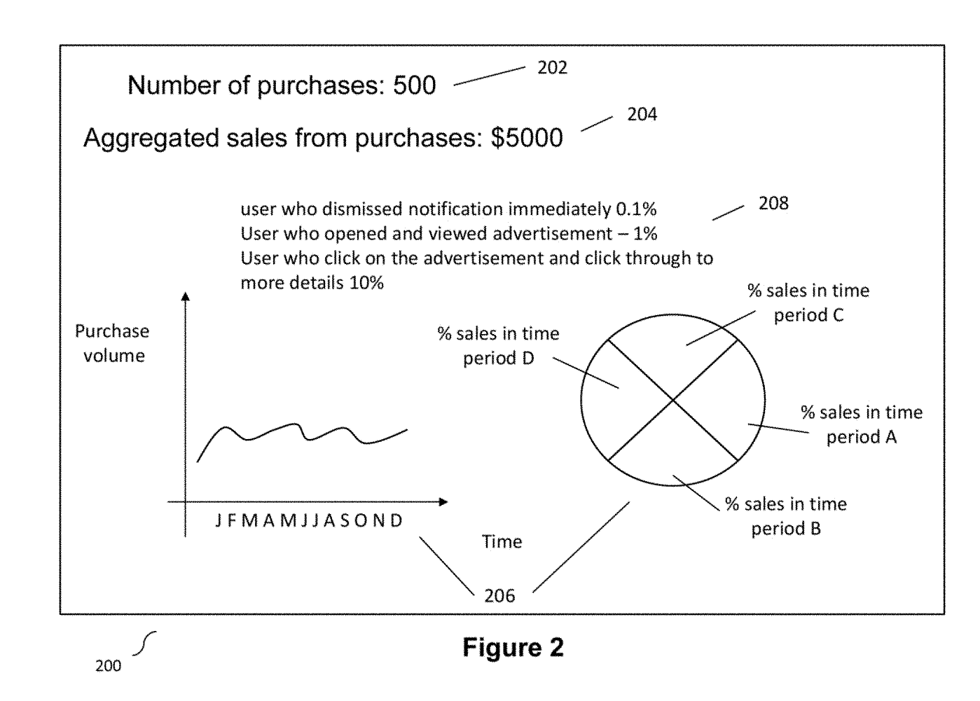

The statistical data that the advertising campaign analyser 118 generates refers to analytics used to assess effectiveness of the advertising campaign and includes any one or more of number of the purchases made at the merchant 102, being attributable to the online advertising campaign; total financial value of the purchases made at the merchant 102, being attributable to the online advertising campaign; one or more charts displaying sales trend of the purchases made at the merchant 102, being attributable to the online advertising campaign; and an extent of engagement with the advertising material. The advertising campaign analyser 118 then compiles a report containing one or more of the generated statistical data. A schematic of the report 250 is shown in FIG. 2, along with the number 252 of the purchases made at the merchant 102, the total financial value 254 of the purchases made at the merchant 102 one or more charts 256 displaying sales trend of the purchases made at the merchant 102; and an extent of engagement with the advertising material 208.

Two possible sequences of events are provided below to exemplify how the system 100 conducts an online advertising campaign and provides an analysis of the effectiveness of the online advertising campaign.

FIG. 1A illustrates a first sequence of events.

In steps 1 and 2, the advertising network server 116 serves advertising material to a recipient account. While FIG. 1A only shows participating websites 120 that receive the advertising material, it will be appreciated that other recipient accounts include personal email accounts, a user account registered with a social media platform and a smartphone application. The advertising network server 116 may keep a record of the recipient accounts to which the advertising material is sent and merchant identifiers 102i of the merchants hosting the advertising material.

In steps 3 and 4, when the user 122 responds to the advertising material, the advertising network server 116 will extract advertising campaign data from the response, where the advertising campaign data includes at least the recipient account to which the advertising material has been served (such as the user 122 Google® user account). Along with the recipient account, the advertising network server 116 may also record the merchant identifier 102i of the merchant hosting the advertising material from the advertising campaign data.

In step 5, the user 122 uses his mobile terminal to access the digital wallet network directory 112. Examples of the digital wallet network directory 112 include servers that host digital wallet applications that are compatible with Android® or Apple® operating systems. The mobile terminal is used to download the digital wallet application 114 in step 6, the digital wallet application 114 being in a format compatible with the operating system of the mobile terminal. During download, installation and/or setup of the digital wallet application 114 in the mobile terminal, a digital wallet identifier 114i of the digital wallet application 114 is assigned and stored in either or both the digital wallet network directory 112 and the mobile terminal. In addition, as mentioned above, an electronic address 114e used to register the digital wallet application 114 may be obtained. The electronic address may for example be a unique identifier of a mobile terminal or an email address of the user 122. The electronic address 114e may be stored in the digital wallet network directory 112. The digital wallet network directory 112 may map the electronic address 114e with the digital wallet identifier 114i to create paired digital wallet identifier and electronic address data 114i-114e. The digital wallet identifier 114i and the paired digital wallet identifier and electronic address data 114i-114e are sent to the advertising network server 116 in step 7.

In step 7, the advertising network server 116 can also map the digital wallet identifier 114i of the digital wallet to an electronic address which the user 122 uses to access the advertising network server 116. The paired digital wallet identifier is stored on the advertising network server 116.

In step 8, the user 122 visits the merchant 102 (either at its online or physical store) which owns the participating website 120 and makes a purchase using the digital wallet application 114. The steps 9a, 9b, 10, 11, 12 and 13 are a sequence of steps which occur at the merchant 102, the acquirer 104, the card scheme network 106 and the issuer 108 that authorizes payment on the digital wallet application 114. The data messages that are exchanged in these steps 9a, 9b, 10, 11, 12 and 13 are well known and therefore not further elaborated in the present disclosure. When these steps are executed, the card scheme network 106 will receive payment data generated from purchases made using the digital wallet application 114. As mentioned above, the payment data includes any one or more of the electronic address 114e used to register the digital wallet application 114, the digital wallet identifier 114i of the digital wallet application 114, the merchant identifier 102i of the merchant 102 from whom the purchases are made and transaction details of the purchases made. These transaction details include the total financial amount and transaction details of the purchases made, and the transaction date and time. The payment data is sent to the card scheme data warehouse 110 for storage in step 14.

Due to regulatory/privacy restrictions, payment card scheme operators are not allowed to reveal transaction data of a particular cardholder directly to the advertising network server 116, such as one operated by Google®. The advertising campaign analyser 118 thus acts as a black box matching system (operated by the card scheme network 106 or a third party) in meeting the objective of determining the effectiveness of an advertising campaign by collecting the necessary data from both the card scheme data warehouse 110 and the advertising network server 116 to perform the effectiveness analysis. Such necessary data is obtained in step 15, the advertising campaign analyser 118 will receive the advertising campaign data from the advertising network server 116 and the payment data from the card scheme data warehouse 110.

Using the advertising campaign data received from the advertising network server 116 and the payment data received from the card scheme data warehouse 110, the advertising campaign analyser 118 will be able to determine purchases attributable to the provision of website links of the participating websites 120 to the digital wallet application 114. That is, the advertising campaign analyser 118 correspondingly matches users 122 that have visited the participating websites 120 and have made a purchase at the merchant 102 using the digital wallet application 114. This is done by having the advertising campaign analyser 118 analyse the received advertising campaign data and the received payment data to identify data fields from the received payment data that establishes a correlation to the at least one recipient account from the received advertising campaign data. The correlation has already been described above and is not further elaborated.

When analysing the received advertising campaign data and the received payment data, the advertising campaign analyser 118 may only consider data sets within the received advertising campaign data and the received payment data that belong to a specific time frame. For example, the analysis may use the advertising campaign data and the payment data that belong to a time frame spanning a validity period of the online advertising campaign. Specifying such a time frame would eliminate received payment data from purchases that share common data fields with received advertising campaign data, but which occurs beyond a window where it would be considered that the user 122 purchase was not influenced by content of the participating website 120 content or where a promotion period of goods or services advertised in the participating website 120 has expired.

The common data fields are any one or more of the registered electronic address 114e, the merchant identifier 102i and the digital wallet identifier 114i. The merchant identifier 102i received in the advertising campaign data and the merchant identifier 102i received in the payment data may not be identical. However, the advertising campaign analyser 118 may contain a look-up table which is able to match the two merchant identifier 102i data by recognising that they refer to the same merchant 102.

Additional common data fields that may be used include the name of the merchant 102, available in both the advertising network server 116 and the card scheme data warehouse 110. In step 15, the merchant 102 name may also be transmitted by the advertising network server 116 to the advertising campaign analyser 118 and by the card scheme data warehouse 110 to advertising campaign analyser 118. Several card scheme data warehouses 110, such as those owned by MasterCard, store merchant 102 names, along with the names of their affiliated companies (such as their parent company), as a group. If the merchant name 102 is used, analysis of both data sets received by the advertising campaign analyser 118 in step 15 may provide insights to the parent company on how to plan an advertising campaign for its subsidiary companies.

For improved accuracy, the advertising campaign analyser 118 can also receive the paired digital wallet identifier and electronic address data 114i-114e from the advertising network server 116 as an additional data field that is used to verify whether a purchase is the result of the user having seen the participating website 120. This would apply in the scenario where digital wallets are of different formats due to the operating system of the mobile device on which they are installed. A data table which can determine that the different identifiers are traceable back to the same user can be referenced when determining whether the advertising material meets its objective of conversion.

Since matching accuracy improves with more details being provided, further details may also be retrieved from the advertising network server 116 to ensure that correct matching datasets in the payment data and the advertising campaign data received by the advertising campaign analyser 118 are used to analyse the effectiveness of the online advertising campaign. For instance, the advertising network server 116 may provide additional details of the merchant 120 to which the participating websites 120 belong, such as address (country, city/state, postal code). This is because such additional details are also available to the card scheme data warehouse 110 and can be provided to the advertising campaign analyser 118 as further data fields that are used in determining whether the correct matching datasets are selected. For physical store purchase, location based advertising can be done and conversion can be tracked, which may assist to deciding only applying certain promotions to a specific store. An algorithm operating at the advertising campaign analyser 118 will filter the received advertising campaign data and the payment data based on the common data fields and the additional details, if any, to select these correct matching datasets.

The advertising campaign analyser 118 then generates a report 200 containing one or more of statistical data related to purchases attributable to the user 122 having responded to advertising material delivered to a recipient account.

FIG. 1B illustrates a second sequence of events.

In step 1, the user 122 uses his mobile terminal to access the digital wallet network directory 112. Examples of the digital wallet network directory 112 include servers that host digital wallet applications that are compatible with Android® or Apple® operating systems. The mobile terminal is used to download the digital wallet application 114 in step 2, the digital wallet application 114 being in a format compatible with the operating system of the mobile terminal. During download, installation and/or setup of the digital wallet application 114 in the mobile terminal, a digital wallet identifier 114i of the digital wallet application 114 is assigned and stored in either or both the digital wallet network directory 112 and the mobile terminal. In addition, as mentioned above, an electronic address 114e used to register the digital wallet application 114 may be obtained. The electronic address may for example be a unique identifier of a mobile terminal or an email address of the user 122. The electronic address 114e may be stored in the digital wallet network directory 112. The digital wallet network directory 112 may map the electronic address 114e with the digital wallet identifier 114i to create paired digital wallet identifier and electronic address data 114i-114e. The digital wallet identifier 114i and the paired digital wallet identifier and electronic address data 114i-114e are sent to the advertising network server 116 in step 7 (described later).

With the digital wallet application 114 installed into the mobile terminal, the advertising network server 116 is thus able to serve advertisements of the merchant 102 goods or services to the mobile terminal. In step 3, the advertising network server 116 locates participating websites 120 (i.e. websites participating in the online advertising campaign supported by the system 100). The advertising network server 116 keeps a record of the merchant identifiers 102i of these participating websites 120 and pushes one or more website links to the participating websites 120 through the digital wallet application 114 in step 4.

In step 5, the user 122 views the served advertisement by clicking on the website link received in the mobile terminal. This response will be recorded by the advertising network server 116 in step 6. The advertising network server 116 will extract advertising campaign data from the response to the website links of the websites participating in the online advertising campaign. As mentioned above, the advertising campaign data includes any one or more of the electronic address 114e used to register the digital wallet application 114, the digital wallet identifier 114i of the digital wallet application 114 and the merchant identifier 102i of the merchant 102 to whom the websites belong.

The advertising network server 116 need not necessarily extract the advertising campaign data from data transmitted by the mobile terminal in step 6. In an alternative implementation, after the advertising network server 116 detects the response in step 6 that the mobile terminal has accessed the websites participating in the online advertising campaign, the advertising network server 116 may extract the advertising campaign data from data stored in the advertising network server 116. Such stored data results from the advertising network server 116 obtaining the electronic address 114e used to register the digital wallet application 114 and the digital wallet identifier 114i of the digital wallet application 114 from the digital wallet network directory 112 in step 7; and from the record of the merchant identifiers 102i of the participating websites 120 pushed to the digital wallet identifier 114i in step 3. The advertising network server 116 will match the merchant identifiers 102i of the participating websites 120, which belong to the merchant 102, that have been served to the corresponding digital wallet application 114. In step 7, the advertising network server 116 can also map the digital wallet identifier 114i of the digital wallet to an electronic address which the user 122 uses to access the advertising network server 116. The paired digital wallet identifier is stored on the advertising network server 116.

In step 8, the user 122 visits the merchant 102 (either at its online or physical store) which owns the participating website 120 and makes a purchase using the digital wallet application 114. The steps 9a, 9b, 10, 11, 12 and 13 are a sequence of steps which occur at the merchant 102, the acquirer 104, the card scheme network 106 and the issuer 108 that authorizes payment on the digital wallet application 114. The data messages that are exchanged in these steps 9a, 9b, 10, 11, 12 and 13 are well known and therefore not further elaborated in the present disclosure. When these steps are executed, the card scheme network 106 will receive payment data generated from purchases made using the digital wallet application 114. As mentioned above, the payment data includes any one or more of the electronic address 114e used to register the digital wallet application 114, the digital wallet identifier 114i of the digital wallet application 114, the merchant identifier 102i of the merchant 102 from whom the purchases are made and transaction details of the purchases made. These transaction details include the total financial amount and transaction details of the purchases made. of the purchases made, and the transaction date and time. The payment data is sent to the card scheme data warehouse 110 for storage in step 14.

Due to regulatory/privacy restrictions, payment card scheme operators are not allowed to reveal transaction data of a particular cardholder directly to the advertising network server 116, such as one operated by Google®. The advertising campaign analyser 118 thus acts as a black box matching system (operated by the card scheme network 106 or a third party) in meeting the objective of determining the effectiveness of an advertising campaign by collecting the necessary data from both the card scheme data warehouse 110 and the advertising network server 116 to perform the effectiveness analysis. Such necessary data is obtained in step 15, the advertising campaign analyser 118 will receive the advertising campaign data from the advertising network server 116 and the payment data from the card scheme data warehouse 110.

Using the advertising campaign data received from the advertising network server 116 and the payment data received from the card scheme data warehouse 110, the advertising campaign analyser 118 will be able to determine purchases attributable to the provision of website links of the participating websites 120 to the digital wallet application 114. That is, the advertising campaign analyser 118 correspondingly match users 122 that have visited the participating websites 120 and have made a purchase at the merchant 102 using the digital wallet application 114. This is done by having the advertising campaign analyser 118 analyse the received advertising campaign data and the received payment data to identify common data fields in both data sets. If one set of the received payment data has such common data fields with a particular data set from the advertising campaign data, then the purchase which generated that set of received payment data is considered to be the result of the participating website 120 (linked to that particular data set from the advertising campaign data) being successful in creating sales.

When analysing the received advertising campaign data and the received payment data, the advertising campaign analyser 118 may only consider data sets within the received advertising campaign data and the received payment data that belong to a specific time frame. For example, the analysis may use the advertising campaign data and the payment data that belong to a time frame spanning a validity period of the online advertising campaign. Specifying such a time frame would eliminate received payment data from purchases that share common data fields with received advertising campaign data, but which occurs beyond a window where it would be considered that the user 122 purchase was not influenced by content of the participating website 120 content or where a promotion period of goods or services advertised in the participating website 120 has expired.

The common data fields are any one or more of the registered electronic address 114e, the merchant identifier 102i and the digital wallet identifier 114i. The merchant identifier 102i received in the advertising campaign data and the merchant identifier 102i received in the payment data may not be identical. However, the advertising campaign analyser 118 may contain a look-up table which is able to match the two merchant identifier 102i data by recognising that they refer to the same merchant 102.

Additional common data fields that may be used include the name of the merchant 102, available in both the advertising network server 116 and the card scheme data warehouse 110. In step 15, the merchant 102 name may also be transmitted by the advertising network server 116 to the advertising campaign analyser 118 and by the card scheme data warehouse 110 to advertising campaign analyser 118. Several card scheme data warehouses 110, such as those owned by MasterCard, store merchant 102 names, along with the names of their affiliated companies (such as their parent company), as a group. If the merchant name 102 is used, analysis of both data sets received by the advertising campaign analyser 118 in step 15 may provide insights to the parent company on how to plan an advertising campaign for its subsidiary companies.

For improved accuracy, the advertising campaign analyser 118 can also receive the paired digital wallet identifier and electronic address data 114i-114e from the advertising network server 116 as an additional data field that is used to verify whether a purchase is the result of the user having seen the participating website 120. This would apply in the scenario where digital wallets are of different formats due to the operating system of the mobile device on which they are installed. A data table which can determine that the different identifiers are traceable back to the same user can be referenced when determining whether the advertising material meets its objective of conversion.

Since matching accuracy improves with more details being provided, further details may also be retrieved from the advertising network server 116 to ensure that correct matching datasets in the payment data and the advertising campaign data received by the advertising campaign analyser 118 are used to analyse the effectiveness of the online advertising campaign. For instance, the advertising network server 116 may provide additional details of the merchant 120 to which the participating websites 120 belong, such as address (country, city/state, postal code). This is because such additional details are also available to the card scheme data warehouse 110 and can be provided to the advertising campaign analyser 118 as further data fields that are used in determining whether the correct matching datasets are selected. This would apply in the scenario where digital wallets are of different formats due to the operating system of the mobile device on which they are installed. A data table which can determine that the different identifiers are traceable back to the same user can be referenced when determining whether the advertising material meets its objective of conversion. An algorithm operating at the advertising campaign analyser 118 will filter the received advertising campaign data and the payment data based on the common data fields and the additional details, if any, to select these correct matching datasets.

The advertising campaign analyser 118 then generates a report 200 containing one or more of statistical data related to purchases attributable to the user 122 having visited the participating websites 120.

FIG. 2 shows a schematic of the report 200 generated by the advertising campaign analyser 118. The statistical data in the report includes any one or more of the number of the purchases 202 made at the merchant 102, being attributable to the online advertising campaign; total financial value 204 of the purchases made at the merchant 102, being attributable to the online advertising campaign; and one or more charts 206 displaying sales trend of the purchases made at the merchant 102, being attributable to the online advertising campaign; and an extent of engagement with the advertising material 208. The number of the purchases 202 made at the merchant 102 and the one or more sales trend charts 206 are obtained from purchases determined to have a match in one or more of the common data fields of the merchant identifier and the digital wallet identifier; and wherein the total financial value 204 of the purchases made at the merchant 102 is obtained from the number of the purchases made at the merchant 102 and the transaction details in the received payment data.

Returning to FIG. 1A or FIG. 1B, this report 200 is generated without infringing data policies. This report 200 can be used by the advertising network server 116 as well as the merchant 102 to measure actual conversion/spend made at a the merchant store 102 attributable to awareness created by the participating websites 120. In step 16, the report 200 is transmitted in response to a request for the report 200, with FIGS. 1A and 1B showing that the report 200 is transmitted to the advertising network server 116. The transmitted report 200 contains a selection of the one or more generated statistical data, the selection being dependent on parameters set out in the request.

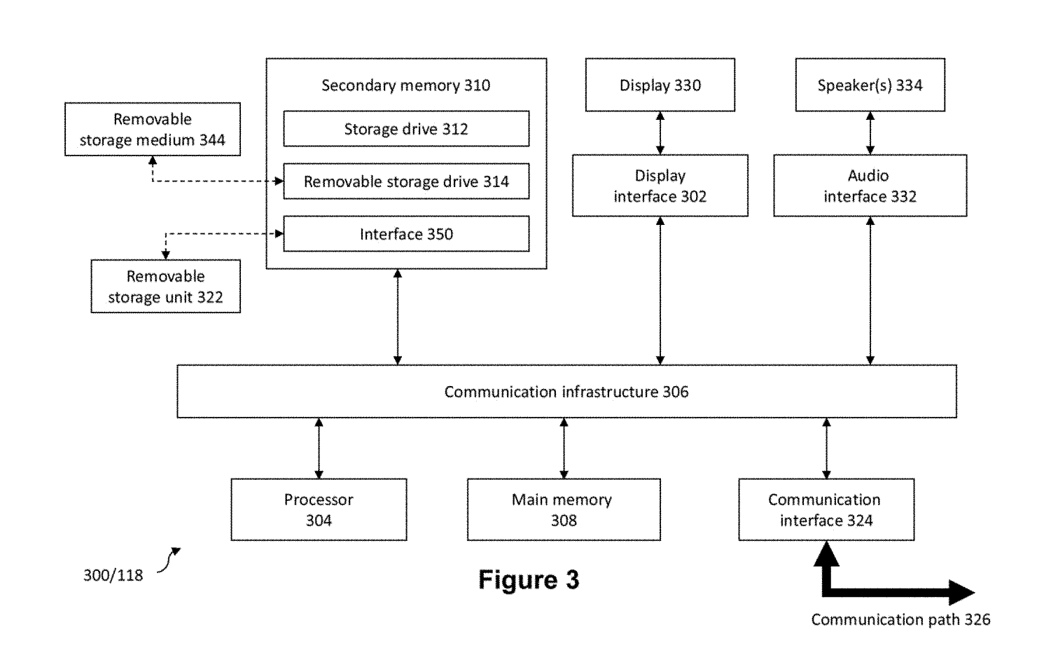

FIG. 3 depicts an exemplary computing device 300, hereinafter interchangeably referred to as a computer system 300, where one or more such computing devices 300 may be used to implement the advertising campaign analyser 118 shown in FIGS. 1A and 1B that measures the effectiveness of an online advertising campaign. The following description of the computing device 300 is provided by way of example only and is not intended to be limiting.

As shown in FIG. 3, the example computing device 300 includes a processor 304 for executing software routines. Although a single processor is shown for the sake of clarity, the computing device 300 may also include a multi-processor system. The processor 304 is connected to a communication infrastructure 306 for communication with other components of the computing device 300. The communication infrastructure 306 may include, for example, a communications bus, cross-bar, or network.

The computing device 300 further includes a main memory 308, such as a random access memory (RAM), and a secondary memory 310. The secondary memory 310 may include, for example, a storage drive 312, which may be a hard disk drive, a solid state drive or a hybrid drive and/or a removable storage drive 314, which may include a magnetic tape drive, an optical disk drive, a solid state storage drive (such as a USB flash drive, a flash memory device, a solid state drive or a memory card), or the like. The removable storage drive 314 reads from and/or writes to a removable storage medium 344 in a well-known manner. The removable storage medium 344 may include magnetic tape, optical disk, non-volatile memory storage medium, or the like, which is read by and written to by removable storage drive 314. As will be appreciated by persons skilled in the relevant art(s), the removable storage medium 344 includes a computer readable storage medium having stored therein computer executable program code instructions and/or data.

In an alternative implementation, the secondary memory 310 may additionally or alternatively include other similar means for allowing computer programs or other instructions to be loaded into the computing device 300. Such means can include, for example, a removable storage unit 322 and an interface 350. Examples of a removable storage unit 322 and interface 350 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 322 and interfaces 350 which allow software and data to be transferred from the removable storage unit 322 to the computer system 300.

The computing device 300 also includes at least one communication interface 324. The communication interface 324 allows software and data to be transferred between computing device 300 and external devices via a communication path 326. In various embodiments of the inventions, the communication interface 324 permits data to be transferred between the computing device 300 and a data communication network, such as a public data or private data communication network. The communication interface 324 may be used to exchange data between different computing devices 300 which such computing devices 300 form part an interconnected computer network. Examples of a communication interface 324 can include a modem, a network interface (such as an Ethernet card), a communication port (such as a serial, parallel, printer, GPIB, IEEE 1394, RJ45, USB), an antenna with associated circuitry and the like. The communication interface 324 may be wired or may be wireless. Software and data transferred via the communication interface 324 are in the form of signals which can be electronic, electromagnetic, optical or other signals capable of being received by communication interface 324. These signals are provided to the communication interface via the communication path 326.

As shown in FIG. 3, the computing device 300 further includes a display interface 302 which performs operations for rendering images to an associated display 330 and an audio interface 332 for performing operations for playing audio content via associated speaker(s) 334.

As used herein, the term “computer program product” may refer, in part, to removable storage medium 344, removable storage unit 322, a hard disk installed in storage drive 312, or a carrier wave carrying software over communication path 326 (wireless link or cable) to communication interface 324. Computer readable storage media refers to any non-transitory, non-volatile tangible storage medium that provides recorded instructions and/or data to the computing device 300 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 300. Examples of transitory or non-tangible computer readable transmission media that may also participate in the provision of software, application programs, instructions and/or data to the computing device 300 include radio or infra-red transmission channels as well as a network connection to another computer or networked device, and the Internet or Intranets including e-mail transmissions and information recorded on Websites and the like.

The computer programs (also called computer program code) are stored in main memory 308 and/or secondary memory 310. Computer programs can also be received via the communication interface 324. Such computer programs, when executed, enable the computing device 300 to perform one or more features of embodiments discussed herein. In various embodiments, the computer programs, when executed, enable the processor 304 to perform features of the above-described embodiments. Accordingly, such computer programs represent controllers of the computer system 300.

Software may be stored in a computer program product and loaded into the computing device 300 using the removable storage drive 314, the storage drive 312, or the interface 350. The computer program product may be a non-transitory computer readable medium. Alternatively, the computer program product may be downloaded to the computer system 300 over the communications path 326. The software, when executed by the processor 304, causes the computing device 300 to perform functions of embodiments described herein.

It is to be understood that the embodiment of FIG. 3 is presented merely by way of example. Therefore, in some embodiments one or more features of the computing device 300 may be omitted. Also, in some embodiments, one or more features of the computing device 300 may be combined together. Additionally, in some embodiments, one or more features of the computing device 300 may be split into one or more component parts. The main memory 308 and/or the secondary memory 310 may serve(s) as the memory for the advertising campaign analyser 118; while the processor 304 may serve as the processor of the advertising campaign analyser 118.

In the case of FIGS. 1A and 1B, the memory (310, 308) contains computer program code, where the memory (310, 308) and the computer program code are configured to, with the processor 304, cause the advertising campaign analyser 118 at least to: receive, through an input port (such as the communication interface 324), advertising campaign data extracted from a response to advertising material belonging to an online advertising campaign, the advertising campaign data comprising at least one recipient account to which the advertising material is delivered. The advertising campaign analyser 118 receives, through the input port, payment data generated from purchases made at a merchant participating in the online advertising campaign. The advertising campaign analyser 118 analyses the received advertising campaign data and the received payment data to identify data fields from the received payment data that establishes a correlation to the at least one recipient account from the received advertising campaign data. The advertising campaign analyser 118 then generates statistical data related to purchases attributable to the online advertising campaign, the attribution being based at least partially on a degree of the established correlation; and compiles a report containing one or more of the generated statistical data.

The identified data fields may comprise one or more of data fields that match the at least one recipient account and data fields traceable to the recipient account.

The advertising campaign analyser 118 may be further configured to identify the data fields traceable to the recipient account by determining whether a referral flag is raised, the referral flag indicating that the advertising material is located through the recipient account.

The degree of the established correlation may depend on whether the identified data fields match the at least one recipient account or are the data fields traceable to the recipient account.

The at least one recipient account may comprise an electronic address, a digital wallet identifier of a digital wallet application and a merchant identifier of a merchant hosting the advertising material.

The received payment data may comprise any one or more of an electronic address, a digital wallet identifier of a digital wallet application and a merchant identifier of the merchant from whom the purchases are made and transaction details of the purchases made.

The identified data fields may match the at least one recipient account when one or more of the electronic address, the digital wallet identifier of the digital wallet application and the merchant identifier of the received advertising campaign data is the same as a respective one of the electronic address, the digital wallet identifier and the merchant identifier of the received payment data.

The generated statistical data may comprise any one or more of: number of the purchases made at the merchant, being attributable to the online advertising campaign; total financial value of the purchases made at the merchant, being attributable to the online advertising campaign; one or more charts displaying sales trend of the purchases made at the merchant, being attributable to the online advertising campaign; and an extent of engagement with the advertising material.

The advertising campaign analyser 118 may be further configured to obtain the number of the purchases made at the merchant and the one or more sales trend charts from purchases determined to have a match in one or more of the merchant identifier and the digital wallet identifier from the received advertising campaign data and the received payment data; and obtain the total financial value of the purchases made at the merchant from the number of the purchases made at the merchant and the transaction details in the received payment data.

The advertising campaign analyser 118 may be further configured to perform the analysis using the advertising campaign data and the payment data that belong to a time frame spanning a validity period of the online advertising campaign.

The advertising campaign analyser 118 may be further configured to transmit the report in response to a request for the report. The transmitted report may contain a selection of the one or more generated statistical data, the selection being dependent on parameters set out in the request.

In the case of FIG. 1B, the memory (310, 308) and the computer program code may be further configured to, with the processor 304, cause the advertising campaign analyser 118 at least to: receive, through the input port advertising campaign data extracted from a response to website links of websites participating in an online advertising campaign, the website links being also provided to a digital wallet application (confer the digital wallet application 114 shown in FIG. 1B). The advertising campaign analyser 118 receives, through the input port, payment data generated from purchases made using the digital wallet application. The advertising campaign analyser 118 analyses the received advertising campaign data and the received payment data to identify common data fields in both data sets. The advertising campaign analyser 118 then generates statistical data related to purchases attributable to the online advertising campaign, the attribution being based at least partially on the identified common data fields and compiles a report containing one or more of the generated statistical data.

The received advertising campaign data may include any one or more of an electronic address used to register the digital wallet application, a digital wallet identifier of the digital wallet application and a merchant identifier of a merchant to whom the websites belong.

The received payment data may include an electronic address used to register the digital wallet application, a digital wallet identifier of the digital wallet application and a merchant identifier of a merchant from whom the purchases are made and transaction details of the purchases made.

The common data fields may include any one or more of the registered electronic address, the merchant identifier and the digital wallet identifier.

The generated statistical data may include any one or more of: number of the purchases made at the merchant, being attributable to the online advertising campaign; total financial value of the purchases made at the merchant, being attributable to the online advertising campaign; and one or more charts displaying sales trend of the purchases made at the merchant, being attributable to the online advertising campaign.

The advertising campaign analyser 118 may be further configured to obtain the number of the purchases made at the merchant and the one or more sales trend charts from purchases determined to have a match in one or more of the common data fields of the merchant identifier and the digital wallet identifier; and obtain the total financial value of the purchases made at the merchant from the number of the purchases made at the merchant and the transaction details in the received payment data.

The advertising campaign analyser 118 may be further configured to perform the analysis using the advertising campaign data and the payment data that belong to a time frame spanning a validity period of the online advertising campaign.

The advertising campaign analyser 118 may be further configured to transmit the report in response to a request for the report. The transmitted report may contain a selection of the one or more generated statistical data, the selection being dependent on parameters set out in the request.

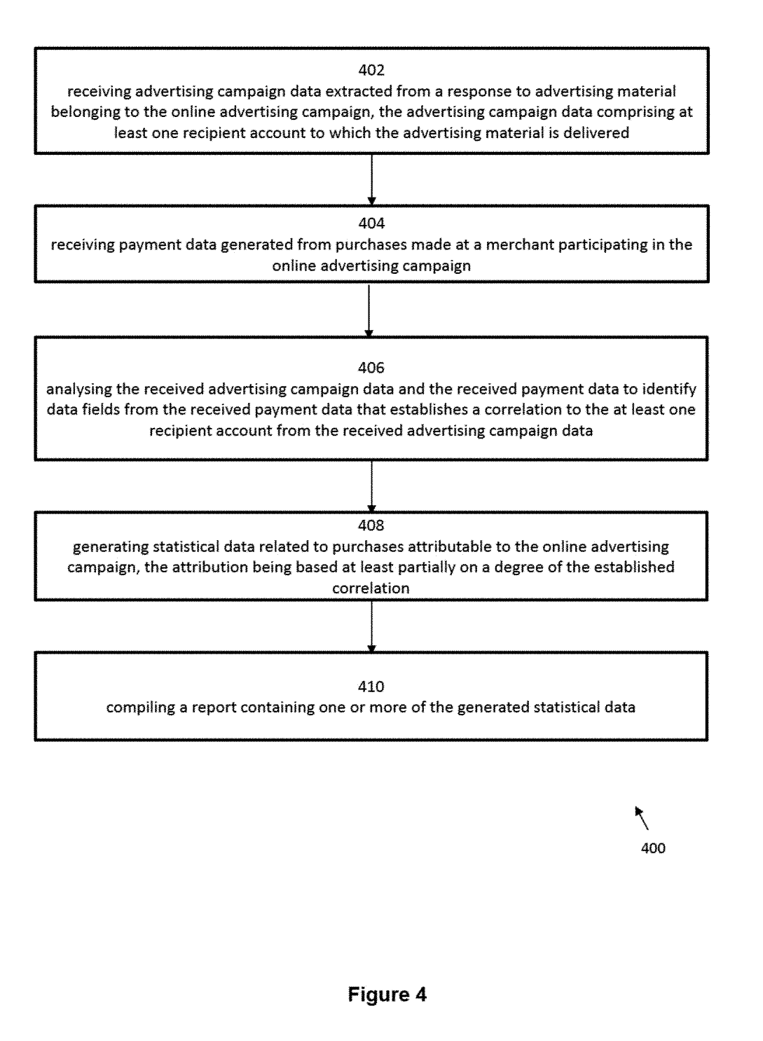

FIG. 4 shows a flowchart depicting steps of a method 400 of analysing effectiveness of an online advertising campaign. The method 400 is performed by the computing device 300 of FIG. 3.

The method 400 comprises a first step 402 of receiving advertising campaign data extracted from a response to advertising material belonging to the online advertising campaign, the advertising campaign data comprising at least one recipient account to which the advertising material is delivered.

A second step 404 involves receiving payment data generated from purchases made at a merchant participating in the online advertising campaign.

A third step 406 involves analysing the received advertising campaign data and the received payment data to identify data fields from the received payment data that establishes a correlation to the at least one recipient account from the received advertising campaign data.

A fourth step 408 involves generating statistical data related to purchases attributable to the online advertising campaign, the attribution being based at least partially on a degree of the established correlation.

A fifth step 410 involves compiling a report containing one or more of the generated statistical data.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. An advertising campaign analyser comprising:
at least one processor; and
at least one memory including computer program code;
an input port coupled to the processor;
the at least one memory and the computer program code configured to, with the at least one processor, cause the analyser at least to:
receive, through the input port, advertising campaign data extracted from a response to advertising material belonging to an online advertising campaign, the advertising campaign data comprising at least one recipient account to which the advertising material is delivered;
receive, through the input port, payment data generated from purchases made at a merchant participating in the online advertising campaign;
analyse the received advertising campaign data and the received payment data to identify data fields from the received payment data that establishes a correlation to the at least one recipient account from the received advertising campaign data;
generate statistical data related to purchases attributable to the online advertising campaign, the attribution being based at least partially on a degree of the established correlation; and
compile a report containing one or more of the generated statistical data.

2. The advertising campaign analyser of claim 1, wherein the identified data fields comprise one or more of data fields that match the at least one recipient account and data fields traceable to the recipient account.

3. The advertising campaign analyser of claim 2, wherein the advertising campaign analyser is further configured to identify the data fields traceable to the recipient account by determining whether a referral flag is raised, the referral flag indicating that the advertising material is located through the recipient account.

4. The advertising campaign analyser of claim 2, wherein the degree of the established correlation depends on whether the identified data fields match the at least one recipient account or are the data fields traceable to the recipient account.

5. The advertising campaign analyser of claim 2, wherein the at least one recipient account comprises an electronic address, a digital wallet identifier of a digital wallet application and a merchant identifier of a merchant hosting the advertising material.

6. The advertising campaign analyser of claim 2, wherein the received payment data comprises any one or more of an electronic address, a digital wallet identifier of a digital wallet application and a merchant identifier of the merchant from whom the purchases are made and transaction details of the purchases made.

7. The advertising campaign analyser of claim 5, wherein the identified data fields matches the at least one recipient account when one or more of the electronic address, the digital wallet identifier of the digital wallet application and the merchant identifier of the received advertising campaign data is the same as a respective one of the electronic address, the digital wallet identifier and the merchant identifier of the received payment data.

8. The advertising campaign analyser of claim 6, wherein the generated statistical data comprises any one or more of:
number of the purchases made at the merchant, being attributable to the online advertising campaign;
total financial value of the purchases made at the merchant, being attributable to the online advertising campaign;
one or more charts displaying sales trend of the purchases made at the merchant, being attributable to the online advertising campaign; and
an extent of engagement with the advertising material.

9. The advertising campaign analyser of claim 8, wherein the advertising campaign analyser is further configured to
obtain the number of the purchases made at the merchant and the one or more sales trend charts from purchases determined to have a match in one or more of the merchant identifier and the digital wallet identifier from the received advertising campaign data and the received payment data; and
obtain the total financial value of the purchases made at the merchant from the number of the purchases made at the merchant and the transaction details in the received payment data.

10. The advertising campaign analyser of claim 1, wherein the advertising campaign analyser is further configured to perform the analysis using the advertising campaign data and the payment data that belong to a time frame spanning a validity period of the online advertising campaign.

11. A method of analysing effectiveness of an online advertising campaign, the method comprising:
receiving advertising campaign data extracted from a response to advertising material belonging to the online advertising campaign, the advertising campaign data comprising at least one recipient account to which the advertising material is delivered;
receiving payment data generated from purchases made at a merchant participating in the online advertising campaign;
analysing the received advertising campaign data and the received payment data to identify data fields from the received payment data that establishes a correlation to the at least one recipient account from the received advertising campaign data;
generating statistical data related to purchases attributable to the online advertising campaign, the attribution being based at least partially on a degree of the established correlation; and
compiling a report containing one or more of the generated statistical data.

12. The method of claim 11, wherein the identified data fields comprise one or more of data fields that match the at least one recipient account and data fields traceable to the recipient account.

13. The method of claim 12, wherein identification of the data fields traceable to the recipient account comprises determining whether a referral flag is raised, the referral flag indicating that the advertising material is located through the recipient account.

14. The method of claim 12, wherein the degree of the established correlation depends on whether the identified data fields match the at least one recipient account or are the data fields traceable to the recipient account.

15. The method of claim 12, wherein the at least one recipient account comprises an electronic address, a digital wallet identifier of a digital wallet application and a merchant identifier of a merchant hosting the advertising material.

16. The method of claim 12, wherein the received payment data comprises any one or more of an electronic address, a digital wallet identifier of a digital wallet application and a merchant identifier of the merchant from whom the purchases are made and transaction details of the purchases made.

17. The method of claim 15, wherein the identified data fields matches the at least one recipient account when one or more of the electronic address, the digital wallet identifier of the digital wallet application and the merchant identifier of the received advertising campaign data is the same as a respective one of the electronic address, the digital wallet identifier and the merchant identifier of the received payment data.

18. The method of claim 16, wherein the generated statistical data comprises any one or more of:
number of the purchases made at the merchant, being attributable to the online advertising campaign;
total financial value of the purchases made at the merchant, being attributable to the online advertising campaign; and
one or more charts displaying sales trend of the purchases made at the merchant, being attributable to the online advertising campaign; and
an extent of engagement with the advertising material.

19. The method of claim 18,
wherein the number of the purchases made at the merchant and the one or more sales trend charts are obtained from purchases determined to have a match in one or more of the merchant identifier and the digital wallet identifier from the received advertising campaign data and the received payment data; and
wherein the total financial value of the purchases made at the merchant is obtained from the number of the purchases made at the merchant and the transaction details in the received payment data.

20. The method of claim 11, wherein the analysis uses the advertising campaign data and the payment data that belong to a time frame spanning a validity period of the online advertising campaign.
